(19) United States
(12) Patent Application Publication
(10) Pub. No.: US 2009/0322744 A1
(43) Pub. Date: Dec. 31, 2009

(54) SYSTEM AND METHOD FOR DISPLAYING PICTURES IN DIGITAL PHOTO FRAME

(75) Inventor: QING-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD ., Shenzhen City (TW); HON HAI PRECISION INDUSTRY CO., LTD., Tu-Cheng (TW)

(21) Appl. No.: 12/237,226

(22) Filed: Sep. 24, 2008

(30) Foreign Application Priority Data
Jun. 27, 2008 (CN) 200810302397.4

(51) Int. Cl. G06T 17/00

(52) U.S. Cl. 345/420

(57) ABSTRACT

A method for displaying pictures in a digital photo frame includes establishing a solid figure in three-dimensional space, attaching the pictures to different faces of the solid figure, and rotating the solid figure with the pictures attached thereon to dynamically display the pictures in three-dimensional space.

### BACKGROUND

1. Technical Field

The present invention relates to a system and method for displaying pictures in a digital photo frame.

2. Description of Related Art

A typical digital photo frame usually includes a display screen, a card reader, and a control chip. Pictures stored in the typical digital photo frame can be dynamically displayed on the display screen one by one. However, the typical digital data frame can only display the pictures in two-dimensional space.

What is needed, therefore, is a system and method for displaying the pictures of a digital photo frame in three-dimensional space.

### BRIEF DESCRIPTION OF THE DRAWINGS

FIG. 1 is a schematic block diagram of an embodiment of a digital photo frame;

FIG. 2 illustrates a system in which the two-dimensional pictures are displayed in three-dimensional space; and

FIG. 3 is a flow chart of an embodiment of a method for displaying pictures in the digital photo frame.

### DETAILED DESCRIPTION

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

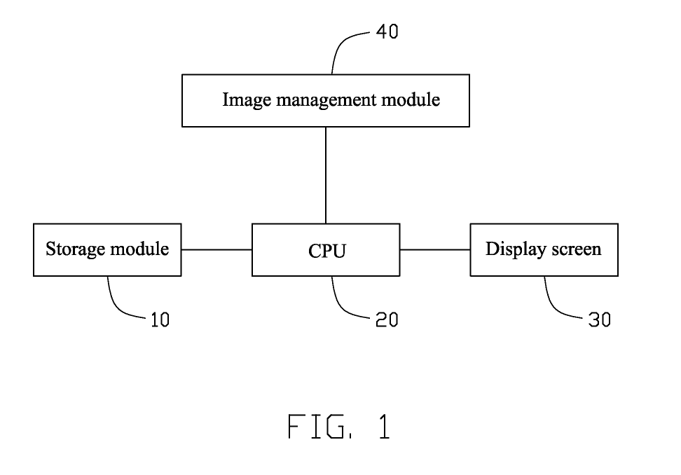

Referring to FIG. 1, an embodiment of a digital photo frame includes a storage module 10 for storing digital image files, a central processing unit (CPU) 20 for processing the digital image files to be displayed, a display screen 30, and an image management module 40 for processing the digital image files to be displayed in a three-dimensional view.

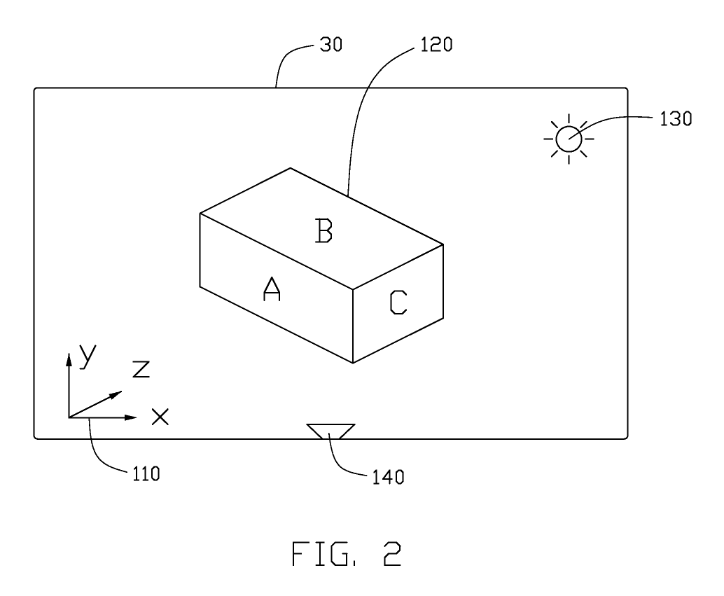

Referring to FIG. 2, an embodiment of a system for showing the pictures in three-dimensional space includes a three-dimensional frame of reference 110, a three-dimensional exemplary solid figure 120 shown with pictures A, B, C, attached thereon, a virtual light source 130, and a virtual camera 140. The solid figure 120 with the attached pictures is displayed on the display screen 30 of the digital photo frame.

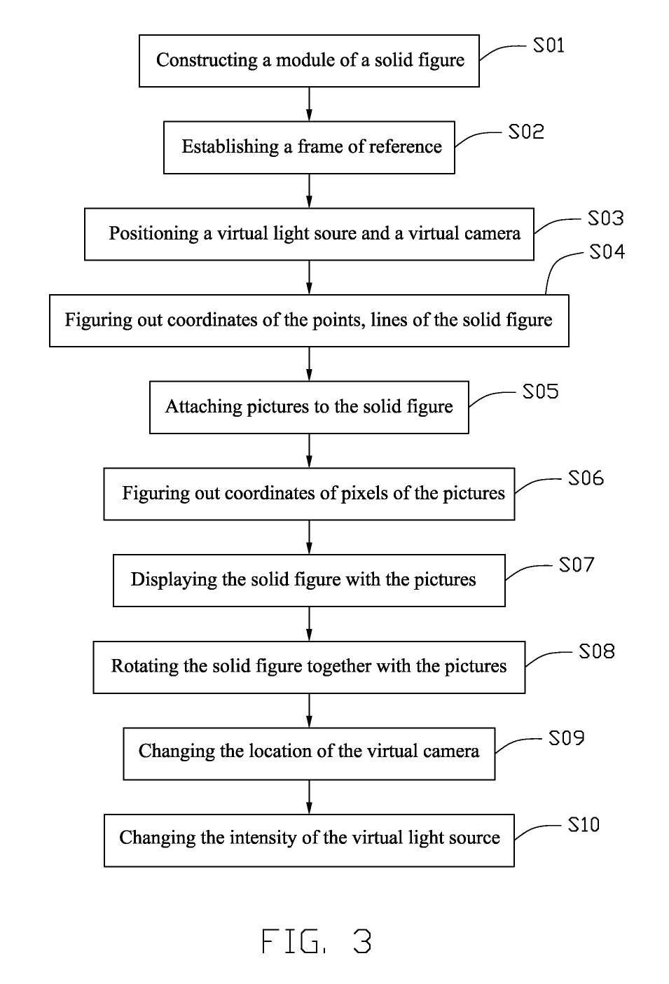

Referring to FIG. 3, is a flowchart for displaying the pictures in the digital photo frame. Depending on the embodiment, certain of the steps described below may be removed, others may be added, and the sequence of steps may be altered.

In a block S01, a model of a solid figure 120 in three-dimensional space is constructed. The solid figure 120 has a plurality of surfaces, a plurality of edges, and a plurality of corners. For example, a cuboid solid figure has six surfaces, twelve edges, and six corners.

Continuing to a block S02, a three-dimensional frame of reference 110 is established.

Moving to a block S03, a virtual light source 130 and a virtual camera 140 are positioned in the frame of reference. The virtual light source 130 enables the pictures to be visible. The virtual camera 140 acts as a view point of the pictures on the solid figure 120. A location of the virtual camera 140 determines a viewing angle the digital images are displayed.

Continuing to a block S04, coordinates of the corners and the edges of the solid figure 120 are mapped in the frame of reference 110 to obtain a precise location of the solid figure 120 in the frame of reference 110.

Moving to a block S05, pictures stored in the digital photo frame are selected and attached to the surfaces of the solid figure 120. For example, if the solid figure 120 is cuboid, six pictures will be attached to the six surfaces of the solid figure 120.

Continuing to a block S06, coordinates of pixels of the pictures are calculated according to the location of the pictures attached to the solid figure in the frame of reference.

Moving to a block S07, the solid figure 120 with the attached pictures is displayed on the display screen 30.

Continuing to a block S08, the solid figure 120 together with the pictures is rotated to dynamically present the pictures as if they are three-dimensional.

Moving to a block S09, the location of the virtual camera 140 is changed to present the pictures at various view angles.

Continuing to a block S10, an intensity of the virtual light source 130 is changing to present the pictures within various luminous intensities.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for displaying pictures in a digital photo frame, comprising:
establishing a solid figure in three-dimensional space, wherein the solid figure has a plurality of faces;
attaching the pictures to the faces of the solid figure; and
rotating the solid figure with the pictures attached thereon to dynamically display the pictures in three-dimensional space.

2. The method of claim 1, further comprising establishing a three-dimensional frame of reference in which the solid figure is established after establishing a solid figure, but before attaching the pictures.

3. The method of claim 2, wherein the solid figure is a cuboid and has six pictures; each picture is attached to a corresponding one of the faces.

4. The method of claim 2, further comprising positioning a light source in the frame of reference after establishing a frame of reference, but before attaching the pictures.

5. The method of claim 4, further comprising positioning a virtual camera in the frame of reference after establishing a frame of reference, but before attaching the pictures.

6. The method of claim 5, further comprising changing a location of the virtual camera to generate views of the pictures at various view angles.

7. The method of claim 6, further comprising changing an intensity of the light source to show the pictures in various light intensities.

8. A system for displaying two dimensional pictures in three-dimensional space, comprising:
a solid figure having a plurality of faces, wherein the pictures are attached to the faces;
a light source for making the pictures visible; and
a display for displaying the pictures on the solid figure;
wherein the pictures are rotatable together with the solid figure; an intensity of the light source is changeable.

9. The system of claim 8, wherein the solid figure and light source are established in a three-dimensional frame of reference.

10. The system of claim 9, further comprising a virtual camera acting as a view point of the pictures on the solid figure; a location of the camera is changeable to present the pictures at various view angles.

11. The system of claim 10, wherein the display is a display screen of a digital photo frame.

12. The system of claim 9, wherein the solid figure is a cube.
